(19) United States
(12) Patent Application Publication
(10) Pub. No.: US 2014/0106627 A1
(43) Pub. Date: Apr. 17, 2014

(54) Reconfigurable Terminal with Multiple Configurations

(71) Applicant: LEVITON MANUFACTURING CO., INC., Melville, NY (US)

(72) Inventor: Jerry R. Hoffman, Hickory, NC (US)

(73) Assignee: LEVITON MANUFACTURING CO., INC., Melville, NY (US)

(21) Appl. No.: 13/652,571

(22) Filed: Oct. 16, 2012

(51) Int. Cl. H01R 4/48; H01R 43/26

(52) U.S. Cl. CPC H01R 4/48; H01R 43/26
USPC 439/863; 29/876; 29/857

(57) ABSTRACT

An electrical receptacle terminal includes a contact portion having a plurality of tabs, a clamp having a notch on one end and an aperture on a second end, and a fastener that engages the clamp aperture. The notch on the clamp is configured to receive any one of the plurality of tabs on the contact portion, so that the contact portion is substantially perpendicular to the clamp. The configuration of the terminal varies depending on which one of the plurality of tabs of the contact portion is engaged with the notch on the clamp. The positioning of the clamp in relation to the contact portion, and the ability to configure a terminal in a different orientation with the same component parts, allows for substantially identical terminal components to be used in one or more receptacle terminals as well as substantially identical terminal components across different types of receptacles.

### FIELD OF THE DISCLOSURE

The present disclosure relates generally to a reconfigurable terminal for an electrical receptacle device, and more particularly relates to an apparatus and method for a reconfigurable terminal that can be used with multiple electrical receptacle configurations.

### BACKGROUND OF THE INVENTION

Terminals are components of various electrical devices such as receptacles, switches, lampholders, lighting controls, and the like. In the case of electrical receptacles, terminals are used to connect the electrical supply power to the plug blades of an electrical plug. Terminals may directly receive the blades of electrical plugs, or they may supply power to blades of a plug through other electrical components. There are a number of different receptacle blade configurations/geometries such as those configurations standardized by the National Electrical Manufacturers Association (NEMA), and the configuration or orientation of the terminals in the receptacle may vary depending on the blade configuration of the particular receptacle. In addition, different types of electrical receptacles, including surface-mounted receptacles and flush-mounted receptacles, can be of different depths. Thus, the general configuration of a terminal for a specific application may vary as to geometry, orientation and/or size of the terminals in the receptacle in dependence upon the geometry, size and/or depth requirements of the receptacle.

It is not uncommon that different types and/or models of receptacles have different or unique terminal component parts to account for the varying sizes and/or blade configurations. In addition, even one receptacle can include a number of unique terminal component parts to account for the different blade configurations within the one receptacle. These unique terminal component parts that vary by size and/or configuration increase manufacturing complexity and costs.

Therefore, it would desirable to have a universal/reconfigurable terminal that can be used in various types of receptacle devices, where the devices may be of different depths and/or require different blade configurations. It would also be desirable to have a universal/reconfigurable terminal capable of multiple configurations so that multiples of one type of terminal can be used in a single receptacle where multiple terminal configurations are required. A universal/reconfigurable terminal would decrease the number of unique parts required for manufacturing receptacle devices, which would reduce manufacturing complexity and costs, including inventory costs, labor costs, molding costs, etc.

### SUMMARY OF THE INVENTION

An electrical receptacle terminal for receiving an electrical plug blade including: a contact portion having a tabbed end including a plurality of tabs and a plug blade end configured to receive said electrical plug blade; a clamp having an aperture and a first notch, wherein the notch is arranged and configured to engage any one of the plurality of tabs of the contact portion; and, a fastener having a surface that is adapted and configured for selectively and securingly engaging the aperture of the clamp. The terminal is capable of being configured into a plurality of configurations depending on which one of the plurality of tabs that the first notch engages.

An electrical receptacle, which includes a plurality of the terminals described above, is disclosed. The receptacle includes a cover plate or cover portion having an opening for one or more sockets with a plurality of apertures to receive an electrical plug, and a base portion that receives the cover plate or cover portion and has a plurality of openings that are each configured to receive one of the terminals. Each of the plurality of terminals is in a terminal configuration position that aligns with one of the apertures in the socket and one of the openings in the base portion.

A method for assembling an electrical receptacle terminal is disclosed. The method includes engaging one of the plurality of tabs of the contact portion with a notch in a clamp, wherein any one of the plurality of tabs engages with the notch according to a desired or predetermined orientation. The method may also include inserting a fastener into an aperture of the clamp, wherein the fastener has a surface that is configured for selectively and securingly engaging the aperture in the clamp.

A method of assembling an electrical receptacle for receiving an electrical plug having a plurality of plug blades with predetermined plug blade orientations is disclosed. The method includes assembling a plurality of terminals having terminal orientations corresponding to the plurality of plug blades, respectively, wherein each terminal assembly includes the steps described above. The method also includes inserting each of the plurality of terminals into one of a plurality of openings in a base portion according to the desired or predetermined orientation.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the present invention may be more readily understood by one skilled in the art with reference being had to the following detailed description of several embodiments thereof, taken in conjunction with the accompanying drawings wherein like elements are designated by identical reference numerals throughout the several views, and in which:

FIG. 1 is an exploded view of a terminal according to one embodiment of the present invention, including a contact portion, a clamp, and a fastener;

FIG. 2 is an isometric view of the terminal shown in FIG. 1, wherein the terminal is in a first terminal configuration position;

FIG. 3A is an isometric view of the terminal shown in FIG. 1, wherein the terminal is in a second terminal configuration position;

FIG. 3B is an isometric view of the terminal shown in FIG. 1, wherein the terminal is in a third terminal configuration position;

FIG. 4A is an isometric view of the clamp shown in FIG. 1;

FIG. 4B is a top view of the clamp shown in FIG. 1;

FIG. 5 is a side view of the terminal shown in FIG. 3A, wherein the terminal is in a second terminal configuration position;

FIG. 6 is the terminal shown in FIG. 3A, including a conductor in the channel of the terminal clamp;

FIG. 7 is an exploded view of one embodiment of an electrical receptacle, including a plurality of terminals of the present invention;

FIGS. 8A-8G include top views of exemplary NEMA blade configurations, wherein each configuration includes a plurality of apertures;

FIG. 9A is a bottom view of a plurality of plug blades that are in the same NEMA 10-30 blade configuration as FIG. 8C, wherein each plug blade is engaged with a terminal; and

FIG. 9B is an isometric view of a plurality of plug blades that are in the same NEMA 10-30 blade configuration as FIG. 8C, wherein each plug blade is engaged with a terminal.

### DETAILED DESCRIPTION

The present disclosure describes a terminal for a wiring device such as an electrical receptacle, wherein the electrical receptacle receives plug blades of an electrical plug. Embodiments will be described below while referencing the accompanying figures. The accompanying figures are merely examples and are not intended to limit the scope of the present disclosure. The terminal can be employed on any suitable wiring device such as but not limited to receptacles, switches, lighting/fan speed controls, dimmers, HVAC equipment/controllers, and the like.

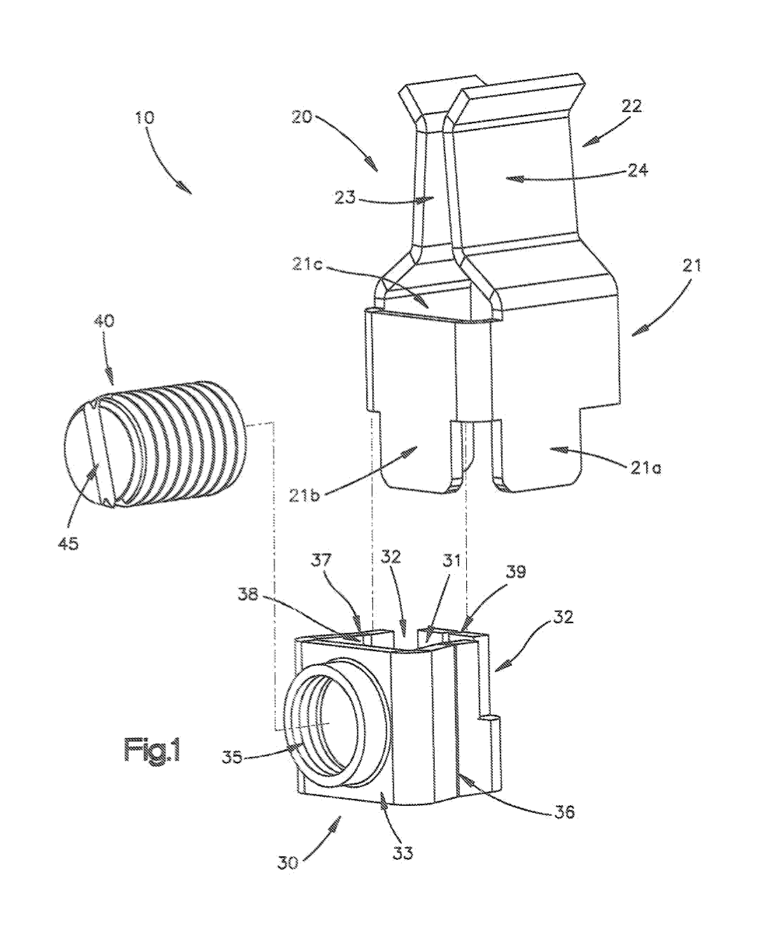

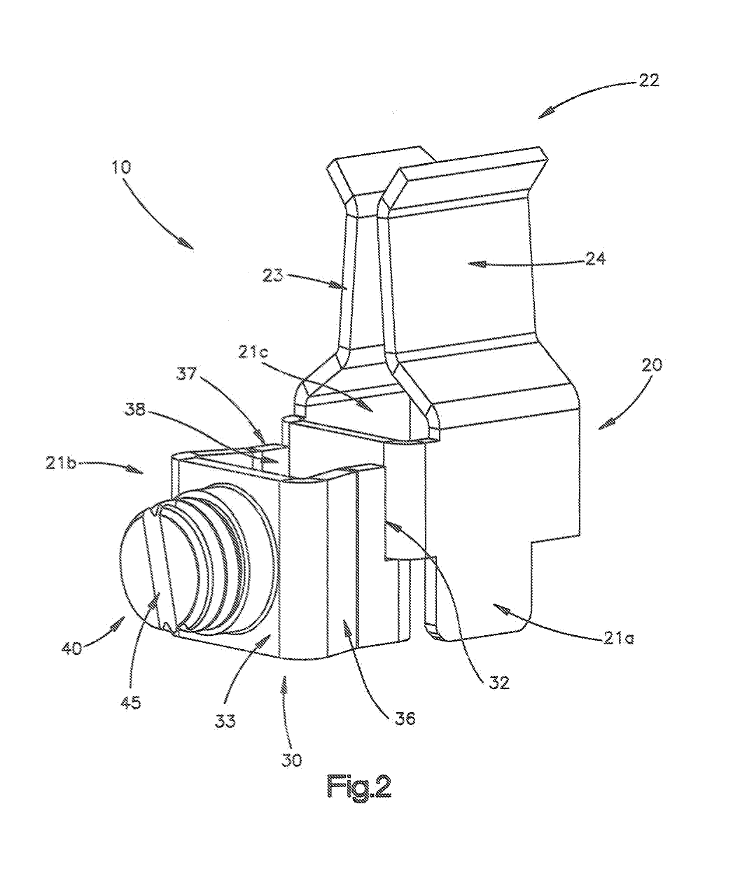

FIGS. 1-2 show an exemplary embodiment of a terminal 10. FIG. 1 shows an exploded view of terminal 10 to show the terminal components separately, and FIG. 2 shows terminal 10 with the components assembled. In this exemplary embodiment, terminal 10 includes a contact portion 20, a clamp 30, and a fastener 40. The contact portion 20 includes a first end 21 that has a plurality of tabs 21a, 21b, 21c. The exemplary embodiment includes three tabs; however it will be understood by those skilled in the art that the contact portion may include any number of tabs, including but not limited to one tab, two tabs, three tabs, and four tabs, etc. In addition, the tabs may be any one or more of a plurality of different forms, a plurality of different shapes, a plurality of different sizes, etc.

Contact portion 20 has a second end 22 that includes two jaws 23, 24. Jaws 23, 24 are configured to receive a plug blade from an electrical plug (not shown). The ends of the jaws 23, 24 are outwardly directed, as shown in FIGS. 1-2, to facilitate entry of the prong between jaws 23, 24. Jaws 23, 24 may be configured to accept straight plug blades, L-shaped blades, round blades, or any other suitably shaped blades. In addition, the plug blade can be equivalent to a plug prong, ground pin, ground prong, and the like. The contact portion may be a ground contact portion or a power contact portion (phase or neutral).

Contact portion 20 may be composed of any suitable metal or combination of metals, including but not limited to, brass, copper, tin, plated brass, plated copper, any suitable alloy/combination thereof, etc. The plating material may be any suitable material such as, but not limited to, tin. For example, by tin plating the contact, the contact can be made to be compatible with aluminum conductors, thus allowing the requirements of Underwriters Laboratories (UL) standards to be met. The contact portion can be produced from a sheet of metal that is shaped and/or bent into the geometry and/or size of the requirements for the contact portion. In addition, the contact portion can be assembled using a mold and/or by using multiple component pieces of metal, or by any other suitable means or method now known or hereafter developed to those skilled in the art.

As depicted in FIG. 1, clamp 30 may include a first wall 36, a second wall 37, a third wall 31, and a fourth wall 33. The fourth wall 33 includes an aperture 35, which is configured to securingly receive a fastener 40. The third wall 31 may be comprised of one section or multiple sections. As shown in the embodiment in FIG. 1, if the third wall 31 is comprised of multiple sections, then the sections may be separated by one or more optional gaps 39. There are several advantages of the clamp 30 containing optional gap 39 in third wall 31. One advantage of optional gap 39 is that it may decrease the complexity of manufacturing the clamp 30. In addition, optional gap 39 allows the clamp 30 to be tolerant or capable of handling more flex than if the third wall 31 is comprised of one section.

In the exemplary embodiment, first wall 36 and second wall 37 are sloped and angled inward towards third wall 31. However, it should be understood that the walls of clamp 30 need not necessarily be sloped and/or angled, may have slopes of differing angles, may include compound slopes/angles, etc. The length of the walls, angles, and/or wall slopes of the clamp walls may also be the reverse of what is illustrated in the exemplary embodiment. For example, the third wall 31 that includes the notch may be longer than the fourth wall 33 that includes the aperture, the angle between the first wall 36 and the fourth wall 33 may be wider or equal to the angle between the first wall 36 and third wall 31, etc. In addition, it should be understood that the clamp need not necessarily include defined walls. For example, the clamp may be a cylindrical clasp or ring-shaped, include a portion that is cylindrical shaped and a portion that is a wall(s), etc.

First wall 36 and/or second wall 37 may include at least part of first notch 32. In the exemplary embodiment, first wall 36 and second wall 37 each include a portion of the notch 32. However, it should be understood by those skilled in the art that only one of the first and second walls may include at least part of the notch.

First notch 32 is configured to engage tab 21b of contact portion 20. When tab 21b (or 21a, 21c) is engaged with notch 32, X and Y are substantially perpendicular to one another (see FIG. 5). Notch 32 of clamp 30 is configured to receive any one of the plurality of tabs 21a, 21b, 21c of the contact portion 20. Fastener 40 has a surface that is adapted and configured to selectively and securingly engage aperture 35 of clamp 30.

The space between the first wall 36 and the second wall 37 preferably forms a channel 38 for receiving a wire/conductor. The channel 38 allows for a conductor to be received between the first wall 36 and the second wall 37. Preferably, the narrowest part of the channel 38 is wider than the widest conductor that may be received into the channel 38. In some embodiments, fastener 40 is in contact, or interferes with, first wall 36 and/or second wall 37.

Clamp 30 may be composed of any suitable metal, including but not limited to, a steel-plated material, a zinc-plated material, etc. One advantage of using a zinc-plated material is to provide corrosion resistance. Thus, zinc-plating the clamp 30 alleviates the potential issue of corrosion and/or a galvanic reaction due to a contact portion 20 composed of a brass-type material in contact with the clamp 30 composed of a steel-type material. Using a steel-plated material reduces deformation or buckling of the clamp 30 when engaged with the contact portion 20.

Aperture 35 may include “thread-like” features, and fastener 40 may thread into aperture 35 of clamp 30. In addition to or in alternative to the threads in the aperture, first wall 36 and/or second wall 37 may include “thread-like” features which may engage the threads of fastener 40. In other words, the threads in first wall 36 and second wall 37 may form threads which engage at least a portion of fastener 40, even though they may not totally encircle fastener 40. In addition, the walls of the clamp may include “thread-like” features even if the walls are not angled/sloped and even if the clamp is another shape, including, but not limited to ring-shaped, cylindrical, etc.

Fastener 40 may be, but is not limited to, a set screw, a self-tapping screw, clasp, pin, stud, rod, bolt, etc. In addition, fastener 40 may be configured to be driven by any suitable drive configuration, such as, but not limited to, an allen/hex drive, slotted/straight blade drive, Phillips/cross drive, 6-point star/torx drive, square/Robertson drive, or the like. In addition, fastener 40 may have any suitable type of head, or it may be headless as in the case of a set screw. A screw driver or other suitable tool (not shown) may engage groove 45 of the fastener 40. The selection of the drive type for fastener 40 may depend on the intended application and torque requirements of fastener 40. For example, there may be a predefined torque range for a given terminal or application. For example, a minimum amount of torque may be required to ensure a low resistance electrical connection that is also mechanically secure. Conversely, the torque should not exceed a maximum value in order to avoid undesirable deformation. The use of a slotted drive may ensure that sufficient torque is applied while preventing excessive torque. Similarly, a Phillips drive may also be used to prevent excessive torque. One inherent feature of a Phillips drive is that the Phillips bit will cam out of the drive recess above a certain torque. This cam out behavior can be used to ensure excessive torque is not applied.

FIG. 2 shows the components of the terminal 10 in an assembled position. More specifically, the terminal 10 in FIG. 2 is assembled in a first terminal configuration position. To obtain the first terminal configuration position, a first tab 21b of the contact portion 20 is engaged with first notch 32 of clamp 30. When tab 21b is engaged with notch 32 of clamp 30, X is substantially perpendicular to Y (see FIG. 5). Thus, the contact portion 20 is adjacent to, or in a side position in relation to, the clamp 30.

There are several advantages to the contact portion 20 being positioned substantially perpendicular to the clamp 30, as opposed to a conventional terminal where the contact portion is stacked in line with the clamp. One advantage is that the height of the terminals in the disclosed invention may be less than the height of a conventional terminal. Thus, the same terminal can be used in different types of electrical receptacles that have varying depth restrictions, including but not limited to, flush-mount receptacles, surface-mount receptacles, etc. Advantages of reducing the number of unique terminal parts required among different types of receptacles include automating production as well as cutting manufacturing costs, complexity, inventory, etc.

Another advantage of the clamp 30 being in a substantially perpendicular position to the contact portion 20 (and the contact portion 20 having a plurality of tabs) is that the same components of terminal 10 can be assembled in a variety of different configurations. Thus, if an electrical receptacle (see FIG. 7) includes a plurality of blade configurations that require various terminal configurations, then multiples of the same terminal components can be used and just assembled in a different configuration to match each of the respective blade configurations.

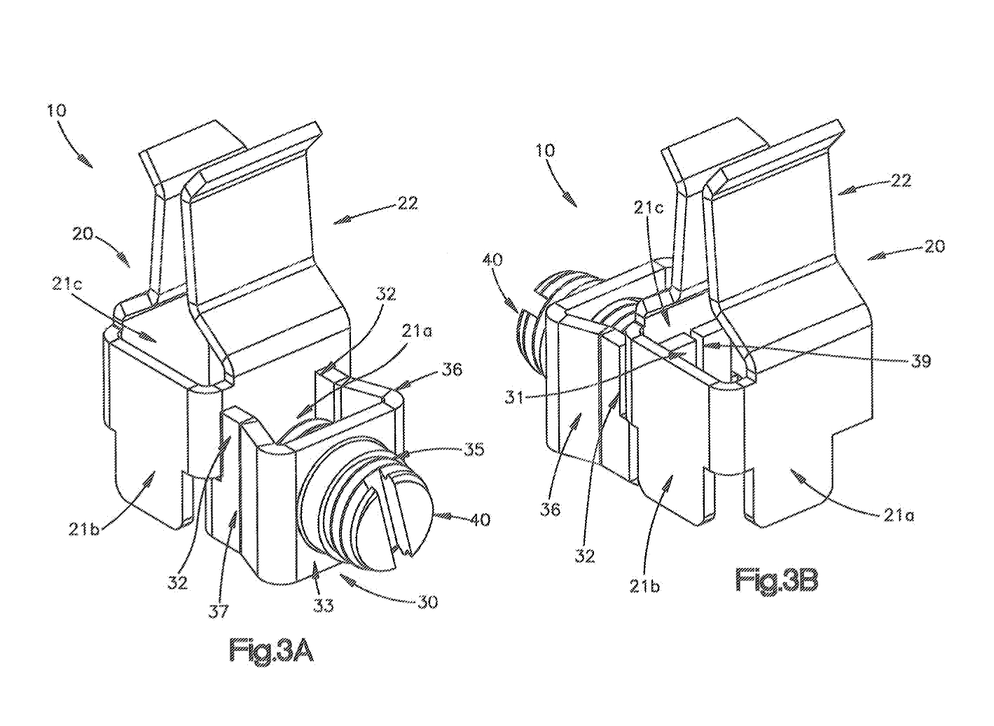

The configuration of the terminal is dependent on which one of the plurality of tabs 21a, 21b, 21c is engaged in the first notch 32 of clamp 30. That is, when one of the plurality of tabs 21a, 21b, 21c is engaged with the notch 32, there is a different configuration position than when any other one of the plurality of tabs 21a, 21b, 21c is engaged with notch 32. For example, in the exemplary embodiment, when a first tab 21b is engaged with notch 32, the terminal is in a first terminal configuration position (as shown in FIG. 2). When a second tab 21a is engaged with notch 32, the terminal is in a second terminal configuration (as shown in FIG. 3A). Lastly, when a third tab 21c is engaged with notch 32, the terminal is in a third terminal configuration position (see FIG. 3B). In each of these configurations, the contact portion 20 is substantially perpendicular to the clamp 30. It should be noted that the number of configuration positions is not limited to three. Rather, the number of potential configurations positions is dependent on the number of tabs on the contact portion, which may be any number of tabs, including but not limited to, one tab, two tabs, three tabs, four tabs, etc.

The ability to configure the terminal in a plurality of different configuration positions allows for one or more terminals in an electrical receptacle to each have the same components (i.e. contact portion 20, clamp 30, and fastener 40) because each terminal can be assembled in a configuration position that would match the configuration of each plug blade aperture in the socket (not shown).

Tabs 21a, 21b, and 21c provide structural joint support when they are engaged with first notch 32 of clamp 30. Torque ratings of the disclosed invention maintains or exceeds torque ratings in conventional terminals for a two-piece device.

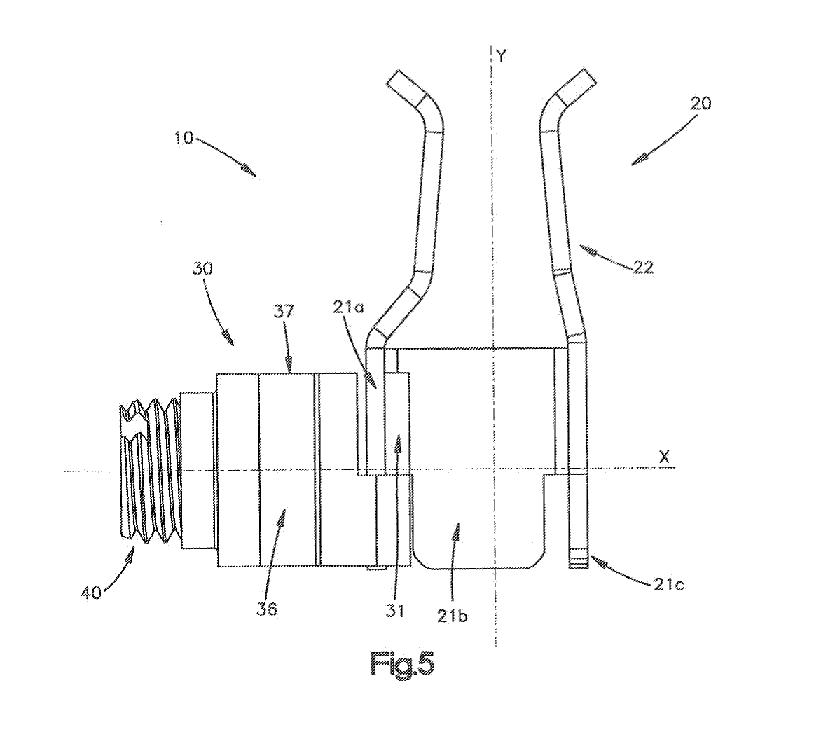

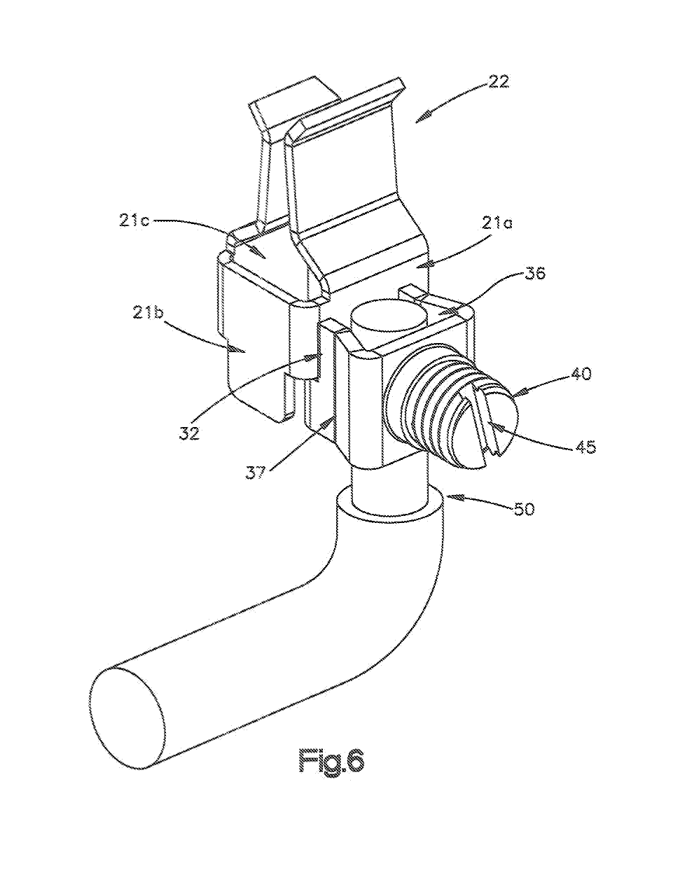

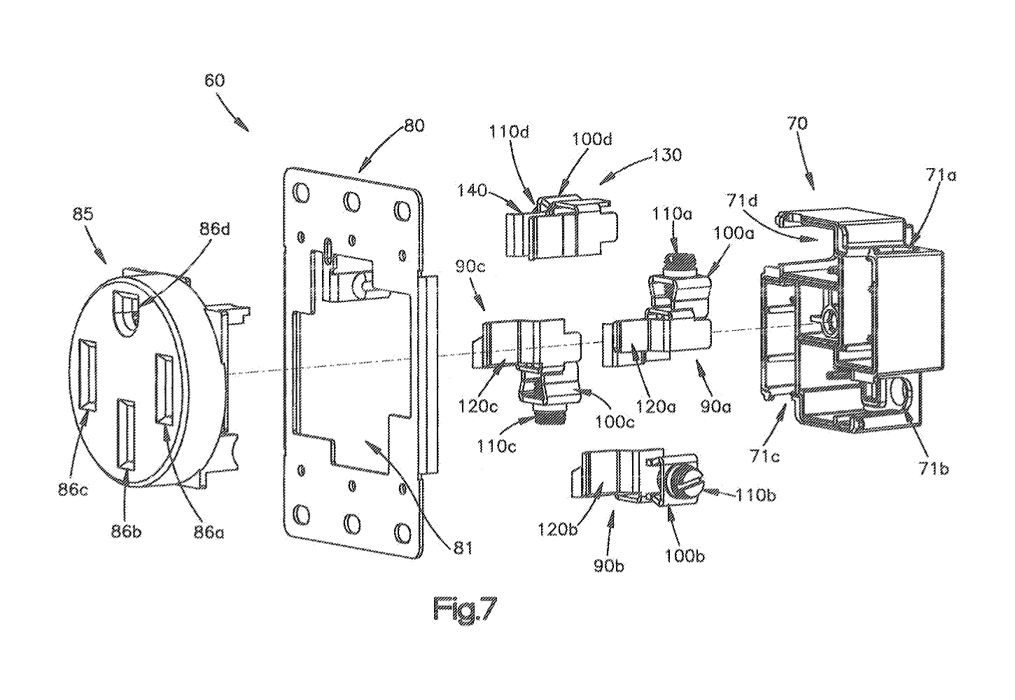

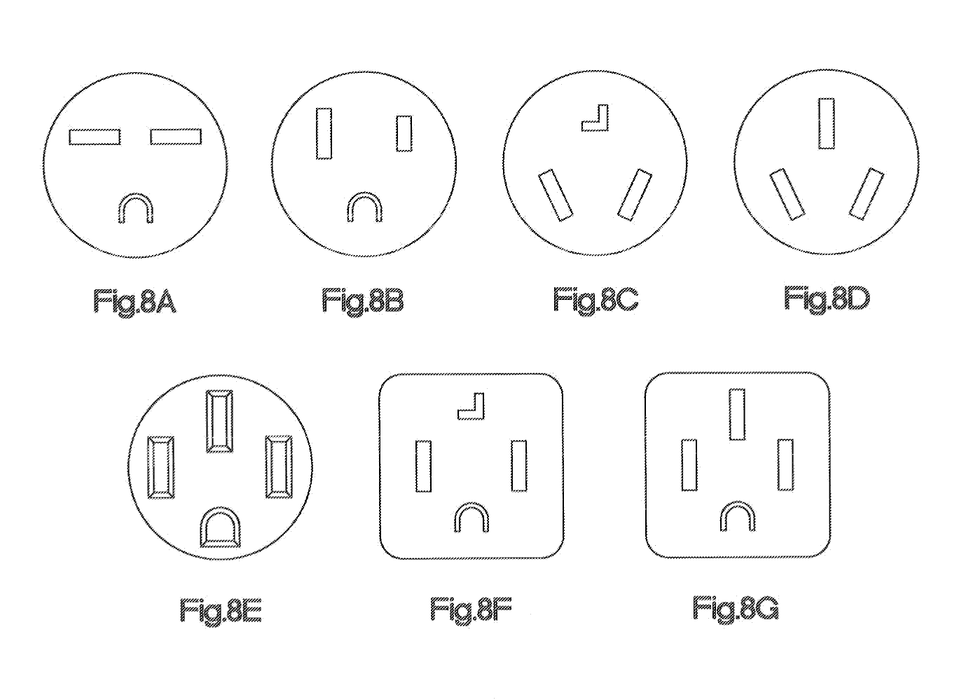

As shown in the exemplary embodiment of FIG. 2, fastener 40 securingly engages the aperture in clamp 30, positioning the fastener 40 in channel 38 of clamp 30 in between the first wall 36 and the second wall 37. In some embodiments, fastener 40 is in contact, or interferes with, first wall 36 and/or second wall 37. Fastener 40 is configured to engage with a conductor (see FIG. 6) that may be in the channel 38. In the exemplary embodiment, when a conductor is in channel 38, fastener 40 is substantially perpendicular to the conductor. In alternate embodiments, the fastener is configured to engage the conductor, but is not necessarily substantially perpendicular to the conductor. Fastener 40 may be tightened a suitable amount so that the conductor presses against one of the plurality of tabs 21a, 21b, 21c that is engaged with notch 32 of clamp 30, keeping the conductor in place while in the channel 38. When tightening, fastener 40 is rotated in a suitable direction and further advanced until the conductor is firmly secured between the fastener and the contact portion.

In another embodiment, the terminal may be a ground terminal. For ground terminals, the clamp component may be the same clamp component as the exemplary embodiment in FIGS. 1-2. In addition, the fastener component of a ground terminal may be the same type of fastener components as the exemplary embodiments in FIGS. 1-2. Thus, if a receptacle has one or more terminals for straight blades and one or more ground terminals, the clamp component in the ground terminal can be the same type of clamp component as used in the straight blade terminals; and the fastener component in the ground terminal can be the same type of fastener component as used in the straight blade terminals. An example of a ground terminal is ground terminal 130 in FIG. 7 (discussed in more detail below).

The contact portion of ground terminals may differ from the contact portion of the terminals in the exemplary embodiments in FIGS. 1-2. The geometry of the jaws of the contact portion for a ground terminal is the same as the geometry of the jaws of the contact portions in the terminal described above in the exemplary embodiment; however, the width between the jaws in the contact portion of a ground terminal is greater than the width between the jaws in the contact portion of the terminal of the exemplary embodiment. This difference in width in the contact portion for the ground terminal accounts for the geometry and size differences of a ground pin of an electrical plug.

FIG. 3A and FIG. 3B are perspective isometric views of terminals in other configuration positions. FIG. 3A shows terminal 10 in a second terminal configuration position. In the second terminal configuration position, tab 21a of contact portion 20 is engaged with notch 32 of clamp 30. Aperture 35 of clamp 30 receives fastener 40. A conductor (not shown) may be placed in channel 38 between first wall 36 and second wall 37, and fastener 40 may be tightened a suitable amount to press the conductor against tab 21a of contact portion 20.

FIG. 3B shows terminal 10 in a third terminal configuration position. In the third terminal configuration position, tab 21c of contact portion 20 is engaged with first notch 32 of clamp 30. Similar to the other configuration positions, aperture 35 of clamp 30 receives fastener 40. However, when a conductor is placed in channel 38 of clamp 30 and fastener 40 is tightened a suitable amount, fastener 40 presses the conductor against tab 21c of contact portion 20.

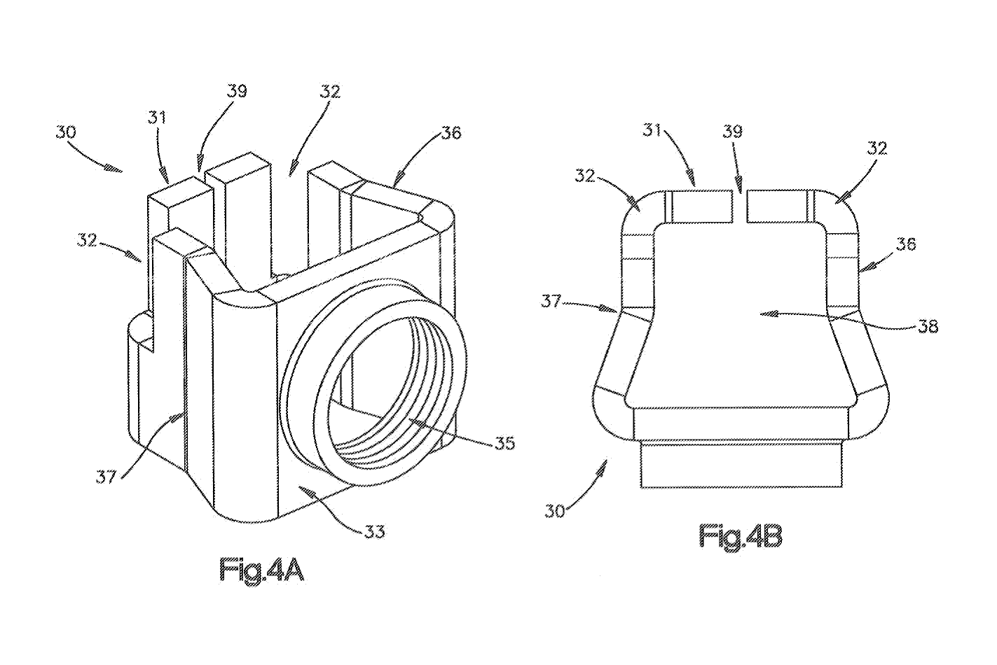

FIG. 4A is a perspective isometric view of clamp 30. Clamp 30 in FIG. 4A is the same view as clamp 30 in terminal 10 of FIG. 3A, which is in the second terminal configuration position. In this embodiment, notch 32 extends through a portion of first wall 36 and second wall 37. Notch 32 only extend partially through the respective walls, as first wall 36 is still attached to third wall 31, and second wall 37 is still attached to third wall 31.

FIG. 4B is a top view of clamp 30. First wall 36 slopes in an inward direction from fourth wall 33 towards third wall 31. Second wall 37 slopes in an inward direction from fourth wall 33 towards third wall 31. Third wall 31 is comprised of two sections, which are separated by optional gap 39. Channel 38 is configured to receive a conductor (not shown).

FIG. 5 shows a side view of terminal 10 that is in the second terminal configuration position (same configuration as terminal 10 in FIG. 3A). Tab 21a of contact portion 20 is engaged with notch 32 of clamp 30, where the contact portion is substantially perpendicular to clamp 30. When tab 21a is engaged with notch 32, X is substantially perpendicular to Y. Aperture 35 of clamp 30 receives fastener 40.

FIG. 6 is an exemplary embodiment of terminal 10 with a conductor 50, wherein terminal 10 is configured in a second terminal configuration position. The first wall 36 and the second wall 37 of clamp 30 are configured to receive a bared end of conductor 50. In addition, fastener 40 is configured to engage conductor 50. Fastener 40 is tightened a suitable amount so that conductor 50 is pressed between fastener 40 and one of the plurality of tabs 21a, 21b, 21c that is engaged with clamp 30, which in this embodiment is tab 21a. As fastener 40 is tightened, it forces the bared end of conductor 50 against tab 21a of contact portion 20, thus retaining the conductor 50 in the channel 38 of clamp 30, ensuring a good electrical connection.

The method of assembling an electrical receptacle terminal 10 for receiving an electrical plug blade includes engaging one of a plurality of tabs 21a, 21b, 21c of a contact portion 20 with first notch 32 of clamp 30, wherein the clamp includes a first notch 32 and an aperture 35; and inserting a fastener into aperture 35 of clamp 30. When assembled, contact portion 20 is substantially perpendicular to clamp 30. Any one of the plurality of tabs 21a, 21b, 21c of the contact portion 20 may engage notch 32 of clamp 30. The one of the plurality of tabs 21a, 21b, 21c chosen to engage with notch 32 depends on the desired or predetermined orientation (i.e. first terminal configuration position, second terminal configuration position, third terminal configuration position) of terminal 10.

In the method of assembling a terminal, the terminal may be a ground terminal, which includes a ground contact portion configured to receive a ground pin. The ground contact portion may, but not necessarily, have the same geometry as contact portions 20, but may have a wider spacing between the jaws to receive a ground pin. The clamp used in the ground terminal may be the same as the clamp 30 used in terminal 10, and the fastener may be the same as the fastener 40 used in terminal 10.

FIG. 7 is an exemplary embodiment of an electrical receptacle 60, wherein a plurality of terminals 90a, 90b, 90c and a ground terminal 130 are incorporated in the embodiment of electrical receptacle 60. In this exemplary embodiment, the receptacle 60 includes: a base portion 70; a cover plate or cover portion 80; a socket 85; a plurality of terminals 90a, 90b, 90c; and a ground terminal 130.

Terminals 90a, 90b, 90c, 130 are each assembled and positioned in accordance with their function and the plug/receptacle configuration. Each of the respective terminals 90a, 90b, 90c (non-ground terminals), may, but not necessarily, include substantially identical components. These components of the respective terminals 90a, 90b, 90c include: a contact portion 120a, 120b, 120c; a clamp 100a, 100b, 100c; and a fastener 110a, 110b, 110c. However, the configurations of these components may vary by terminal 90a, 90b, 90c. Clamp 100d of ground terminal 130 may, but not necessarily, be substantially identical to clamps 100a, 100b, 100c; and, fastener 110d of ground terminal 130 may, but not necessarily, be substantially identical to fasteners 110a, 110b, 110c.

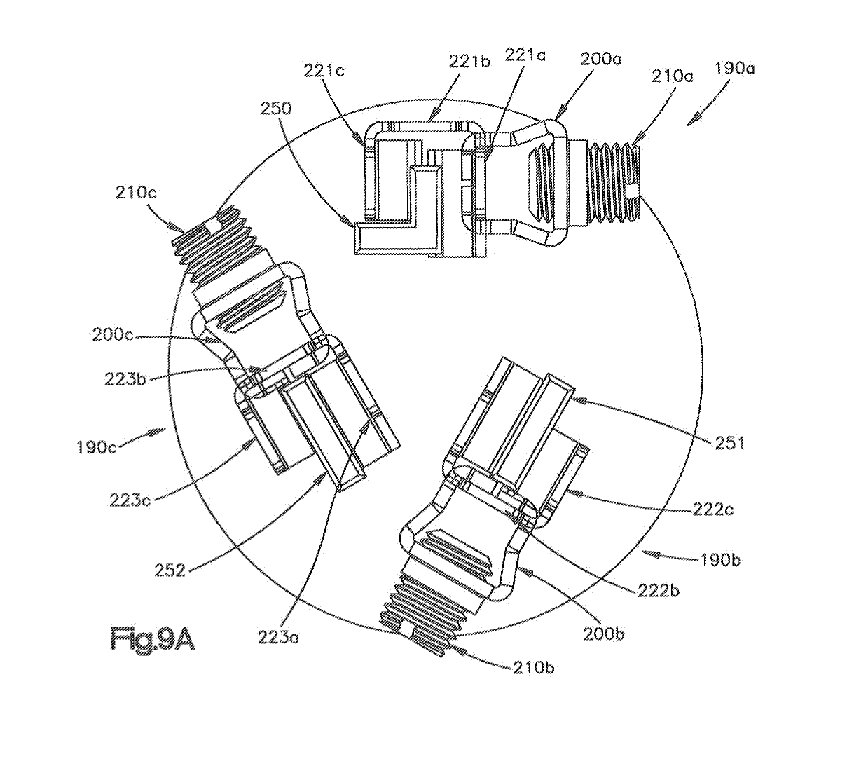

Contact portions 120a, 120b, 120c of terminals 90a, 90b, 90c each include a first end with a plurality of tabs. In this embodiment, the geometry and number of the tabs of the contact portions 120a, 120b, 120c are similar to the geometry described and shown in the exemplary embodiments in FIGS. 1-6; however, it will be understood by those skilled in the art that the tabs on the contact portions can be of any form, shape number, and/or size. As described in the embodiments above, each contact portion 120a, 120b, 120c also has a second end that is configured to receive a plug blade. This second end of contact portion 120a, 120b, 120c may include two jaws configured for a prong of an electrical plug to be received. The ends of each jaw may have a bend that are directed outward to facilitate entry of the prong between the jaws. In this exemplary embodiment, terminals 90a, 90b, 90c are configured and arranged to receive the flat straight prongs of an electrical plug. However, terminals may be configured to receive other types of prongs that may be of different shapes, sizes, etc. For example, terminals may be configured to accept L-shaped prongs, round prongs, or any other suitably shaped prongs (see FIGS. 8A-8G).

Clamps 100a, 100b, 100c (and 100d) may each be substantially identical and are similar to the geometry and features described and shown in the embodiments of FIGS. 1-6. It should be understood that the plurality of clamps do not necessarily have to be substantially identical. As further described in the embodiments above, each of clamps 100a, 100b, 100c (and 100d) include a first notch and an aperture, wherein each of the notches in clamps 100a, 100b, 100c are configured to mate with any one of the plurality of tabs of the respective contact portion 120a, 120b, 120c; and, each of the apertures of clamps 100a, 100b, 100c (and 100d) are configured to receive the respective fastener 110a, 110b, 110c (and 110d). Thus, clamps 100a, 100b, 100c, 100d are interchangeable among one another.

Fasteners 110a, 110b, 110c, 110d may, but not necessarily, be substantially identical to one another and are similar to the features described and shown in the embodiments of FIGS. 1-6. Thus, fasteners 110a, 110b, 110c, 110d are interchangeable among one another. Fasteners 110a, 110b, 110c, 110d are received by the respective apertures in the clamps 100a, 100b, 100c, 100d. After conductors (not shown) are placed in one or more of the channels of clamps 100a, 100b, 100c, 100d, then the fasteners 110a, 110b, 110c, 110d are tightened a suitable amount so that each of the conductors is pressed between the respective fastener 110a, 110b, 110c, 110d and one of the tabs of the respective contact portion 120a, 120b, 120c, 140. The tab of the respective contact portion that is in contact with the conductor is the tab that is engaged in the notch of the respective clamp. For example, a conductor may be placed in the channel of clamp 100a. Fastener 110a may be tightened a suitable amount so that the conductor is pressed against the tab of contact 120a that is engaged with the notch in clamp 100a, thus retaining the conductor in the channel of clamp 100a and ensuring a good electrical connection.

When each of the terminals 90a, 90b, 90c, 130 are assembled, each of the contact portions 120a, 120b, 120c, 140 are substantially perpendicular to each of the respective clamps 100a, 100b, 100c, 100d. The configuration position of the terminals 90a, 90b, 90c, 130 is dependent on which one of the plurality of tabs of the contact portion 120a, 120b, 120c, 140 engages with the notches in the clamps 100a, 100b, 100c, 100d, respectively.

A difference between the plurality of terminals 90a, 90b, 90c may be the configurations of the components. The configurations of the components in each terminal 90a, 90b, 90c may differ according to the respective configuration of each the plurality of apertures 86a, 86b, 86c in socket 85 and/or openings 70a, 70b, 70c in base portion 70. In other words, contact portions 120a, 120b, 120c may, but not necessarily, be each substantially identical; clamps 100a, 100b, 100c may, but not necessarily, be each substantially identical; and, fasteners 110a, 110b, 110c may, but not necessarily, be each substantially identical. But the way each respective contact portion 120a, 120b, 120c is coupled to each respective clamp 100a, 100b, 100c may differ to obtain the required configuration needed to align with the apertures 86a, 86b, 86c in socket 85 and the openings 71a, 71b, 71c in base portion 70. In order for clamp 100a of terminal 90a to align with opening 71a of base portion 70, and for contact portion 120a of terminal 90a to align with aperture 86a of socket 85, the terminal 90a is assembled in a first terminal configuration position (see FIG. 2). Likewise, terminal 90c is also assembled in a first terminal configuration position (see FIG. 2) so that clamp 100c of terminal 90c aligns with opening 71c of base portion 70, and contact portion 120c of terminal 90c aligns with aperture 86c of socket 85. Terminal 90b is assembled in a second terminal configuration position (see FIG. 3A) so that clamp 100b of terminal 90b aligns with opening 71b of base portion 70, and contact portion 120b of terminal 90b aligns with aperture 86b of socket 85. Lastly, ground terminal 130 is assembled in a third terminal configuration position (see FIG. 3B) so that clamp 100d aligns with opening 71d of base portion and ground contact portion 140 aligns with aperture 86d in socket 85.

Ground terminal 130 is configured to receive the ground pin of an electrical plug. Ground terminal 130 has a clamp 100d, which may, but not necessarily, be substantially identical to the clamps 100a, 100b, 100c of the other terminals 90a, 90b, 90c. In addition, ground terminal 130 has a fastener 110d, which may, but not necessarily, be substantially identical to the fasteners 110a, 110b, 110c of the other terminals 90a, 90b, 90c. A difference between the components of the ground terminal 130 and the components of the other terminals 90a, 90b, 90c is the contact portion. Ground contact portion 140 may, but not necessarily, have the same geometry as the other contact portions 90a, 90b, 90c; however, ground contact portion 140 may differ from the other contact portions 90a, 90b, 90c in that the spacing or width between the jaws in the ground contact portion 140 is wider than the spacing or width between the jaws in the other contact portions 90a, 90b, 90c. The wider spacing between the jaws in the ground contact portion 140 accounts for the difference in sizing of the ground pin.

FIG. 7 is an embodiment of an electrical receptacle that includes four terminals in particular configurations. It should be noted that this is an exemplary embodiment, and a different number of terminals and a number of different configurations may be used. The number of terminals used may depend on, but not limited to, NEMA standards, the type of receptacle or other electrical device, the number of plug blades, the number of sockets in the receptacle, etc. The configuration of the terminals depends on the configurations of the apertures in the socket and/or openings in the base portion, which may depend on the type of receptacle. In addition, if the type of receptacle includes one or more openings for ground pins, then one or more of the terminals may be a ground terminal. It also should be noted that each of the contact portions in the terminals in the exemplary embodiment of FIG. 7 have three tabs; however, it will be understood by those skilled in the art that the contact portion may include any number of tabs, including, but not limited to, one tab, two tabs, three tabs, and four tabs, etc.

Base portion 70 includes a plurality of openings 71a, 71b, 71c, 71d. Each of these openings 71a, 71b, 71c, 71d are configured to receive a terminal 90a, 90b, 90c, 130. More specifically, opening 71a receives terminal 90a, opening 71b receives 90b, opening 71c receives terminal 90c, and opening 71d receives ground terminal 130. When terminals 71a, 71b, 71c, 71d are inserted into base portion 70, the outer edges of fasteners 110a, 110b, 110c, 110d are exposed to the external environment due to the openings 71a, 71b, 71c, 71d of the base portion 70. This exposure allows fasteners 110a, 110b, 110c, 110d to be loosened and tightened accordingly when the receptacle 60 is in an assembled position.

The electrical receptacle shown in FIG. 7 includes cover plate or cover portion 80. Cover plate or cover portion 80 includes an aperture for one of more sockets 85. The type and/or size of cover plate used may vary depending on the type of receptacle (i.e. flush-mount receptacle, surface mount receptacle, etc.), size of receptacle, number of sockets (i.e. one, two, three, etc.) in the receptacle, etc. Cover plate or cover portion 80 is configured to align and engage with base portion 70.

Socket 85 includes a plurality of apertures 86a, 86b, 86c, 86d so that plug blades of an appropriate electrical plug (not shown) can be inserted through the apertures 86a, 86b, 86c, 86d and into engagement with the contact portions 120a, 120b, 120c, 140 of terminals 90a, 90b, 90c, 130. In this exemplary embodiment, one of the apertures 86d in socket 85 is configured to receive a ground pin (not shown). Ground terminal 130 is configured to align with the ground aperture 86d in socket 85. The embodiment in FIG. 7 includes one socket, but there can be any number of sockets in the receptacle. In addition, the socket may have any number and any configuration of apertures, depending on a variety of factors, including but not limited to, NEMA standards, the type of electrical plug, the type of electrical receptacle, etc. (See FIG. 8 for other exemplary configurations of socket configurations.)

The method of assembling an electrical receptacle 60, which receives a plurality of plug blades includes assembling a plurality of terminals 90a, 90b, 90c, 130, and aligning each of the plurality of terminals 90a, 90b, 90c, 130 with one of a plurality of openings 71a, 71b, 71c, 71d in a base portion 70. Each of terminals 90a, 90b, 90c, 130 are assembled according to the method described in detail above, and then inserted into base portion 70 according to their function, desired or predetermined orientation, etc. As discussed above, assembling each of the plurality of terminals 90a, 90b, 90c, 130 includes engaging one of a plurality of tabs of a contact portion 120a, 120b, 120c, 140 with the notch of a respective clamp 100a, 100b, 100c, 100d, respectively. Each of the terminals 90a, 90b, 90c, 130 include an end with a plurality of tabs, and each of the clamps 100a, 100b, 100c, 100d includes a notch on one end and an aperture on the opposite end. Each of the contact portions 120a, 120b, 120c, 140 engages with each respective clamp 100a, 100b, 100c, 100d resulting in each of the contact portions 120a, 120b, 120c, 140 being in a substantially perpendicular position to each of the respective clamps 100a, 100b, 100c, 100d. Any one of the plurality of tabs on the contact portion 120a, 120b, 120c, 140 may engage the notch of the respective clamp 100a, 100b, 100c, 100d, the tab chosen being the one that allows the terminal 90a, 90b, 90c, 130 to align with the desired or predetermined orientation required to align with the respective openings 71a, 71b, 71c, 71d of base portion 70 and/or the plurality of apertures 86a, 86b, 86c, 86d in socket 85. Fasteners 100a, 100b, 100c, 100d are then inserted into each of the apertures of clamp 100a, 100b, 100c, 100d.

In the method of assembling the electrical receptacle, one of the terminals may be a ground terminal 130, which includes a ground contact portion 140 configured to receive a ground pin. The ground contact portion 140 may have the same geometry as the other contact portions 120a, 120b, 120c, but has a wider spacing between the jaws to account for a ground pin. The clamp 100d and the fastener 110d may be the same clamp and fastener used in the other terminals 90a, 90b, 90c.

According to the method of assembling the electrical receptacle, the plurality of terminals 90a, 90b, 90c, 130 are each aligned with one of a plurality of openings 71a, 71b, 71c, 71d in the base portion according to the desired or predetermined orientation, and each of the plurality of terminals 90a, 90b, 90c, 130 is inserted into the base portion 70. For example, opening 71a of base portion 70 is positioned in such a way that a terminal in the first terminal configuration position (see FIG. 2) is required. Thus, terminal 90a is assembled in a manner to obtain the first terminal configuration position before the terminal 90a is inserted into the base portion. The orientation of opening 71b of base portion 70 requires a terminal to be in a second terminal configuration position (see FIG. 3A), so the contact portion and clamp of terminal 90b is assembled to obtain a second terminal configuration position. The opening 71c in base portion 70 requires a terminal to be in a first terminal configuration position, so terminal 90c is configured in such a manner to achieve this configuration. Lastly, the opening 71d of base portion 70 is positioned in a manner that requires a terminal to be in the third configuration position (see FIG. 3B). In addition, the configuration of receptacle 60 requires terminal 130 to also be a ground terminal. Thus, a ground contact portion 140 is used for terminal 130, and the ground terminal 130 is assembled in a manner to obtain the third terminal configuration position.

After inserting fasteners 110a, 110b, 110c, 110d into the respective clamp 100a, 100b, 100c, 100d, each of the terminals 90a, 90b, 90c, 130 may be inserted into base portion 70 so that the head of the fasteners 110a, 110b, 110c, 110d are positioned outward, towards, or into each of the openings 71a, 71b, 71c, 71d of base portion 70. The sequence of inserting the terminals 90a, 90b, 90c, 130 into base portion 70 is for illustrative purposes, and the terminals may be inserted into the base portion in any desired order.

The method of assembling the electrical receptacle may further include positioning an end (i.e. bared end) of a conductor in the channel of one or more of the clamps 100a, 100b, 100c, 100d, and tightening each of the respective fasteners 110a, 110b, 110c, 110d to hold the conductor against the tab of the contact portion 120a, 120b, 120c, 140 that is engaged with the respective notch of clamp 100a, 100b, 100c, 100d. As the fastener 110a, 110b, 110c, 110d is tightened, the fastener forces the bared end of the conductor against the tab of the contact portion that is engaged with the respective notch. Thus, the conductor is retained in the channel of the clamp. Further, the method of assembling the electrical receptacle 60 may further include engaging socket 85 with cover plate or cover portion 80, and engaging cover plate or cover portion 80 with base portion 70.

FIGS. 8A-8G are top views of standard blade configurations published by the National Electrical Manufacturers Association (NEMA), wherein each configuration includes a plurality of apertures. These NEMA blade configurations are examples of various plug/receptacle configurations where reconfigurable terminals can be used. It will be understood by those skilled in the art that these blade configurations are non-limiting, and a reconfigurable terminal can be used in any other suitable NEMA blade configurations or non-NEMA blade configurations.

FIG. 8A is a NEMA 6-30 configuration, and FIG. 8B is a NEMA 6-50 configuration. In each of these embodiments, reconfigurable terminals can be used to engage each of the plug blades that extend through the apertures. The clamps used may, but not necessarily, be substantially identical to one another. In addition, the fasteners used may, but not necessarily, be substantially identical to one another. The power contact portions used may, but not necessarily, be substantially identical to one another. The ground contact portions may have the same geometry as the power contact portions, but the ground contact portions may have a wider spacing between the jaws to receive a ground pin. The clamps and contact portions in each terminal can be configured accordingly to align with the NEMA configurations shown and the openings in the base portion (not shown).

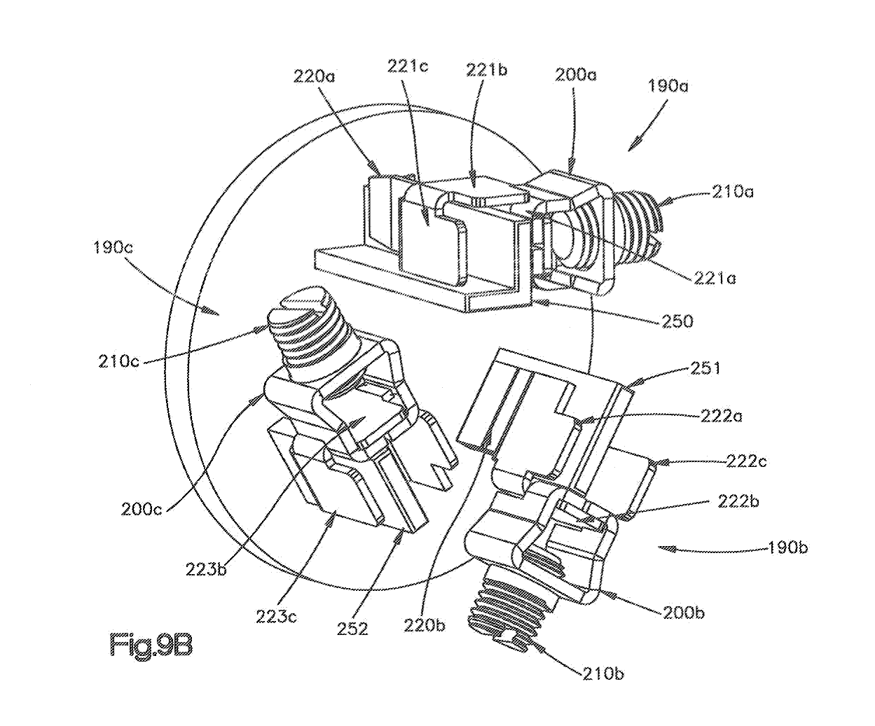

FIG. 8C is a NEMA 10-30 configuration; and, FIG. 8D is a NEMA 10-50 configuration. In both of these embodiments, the three respective terminals may, but not necessarily, include substantially identical contact portions, clamps, and fasteners. However, the three terminals may be configured differently according to a desired or predetermined orientation. FIGS. 9A-9B illustrate terminals that are configured to align with the configuration in the embodiment shown in FIG. 8C, and engage the plug blades.

FIG. 8E and FIG. 8G are NEMA 14-50 configurations. FIG. 8F is a NEMA 14-30 configuration. In each of these embodiments, a reconfigurable terminal can be used to engage each of the four respective plug blades that extend through the apertures. The four terminal clamps (in each of the embodiments) may, but not necessarily, be substantially identical to one another. In addition, the four respective terminal fasteners (in each of the embodiments) may, but not necessarily, be substantially identical to one another. The plurality of power contact portions (in each of the embodiments) may, but not necessarily, be substantially identical to one another. The ground contact portion (in each of the embodiments) may, but not necessarily, have the same geometry as the power contact portions, but the ground contact portions may have a wider spacing between the jaws to receive a ground pin. The clamp and contact portion in each of the terminals in the embodiments can be configured accordingly to align with the NEMA configuration and the openings in the base portion (not shown).

With the exception of the ground terminals, the terminals used among the different NEMA configurations shown in FIGS. 8A-8G may, but not necessarily, include a clamp component that is substantially identical to the clamps used in the other embodiments, a fastener component that is substantially identical to the fasteners used in the other embodiments, and/or a contact portion component that is substantially identical to the contact positions used in the other embodiments. The ground terminals used among the different NEMA configurations shown in FIGS. 8A-8G may, but not necessarily, include a clamp component and/or a fastener component that is substantially identical to the clamps and/or fasteners used in the ground terminals and power contact terminals in the other embodiments. The ground contact portions used among the different embodiments of FIGS. 8A-8G may, but not necessarily, be substantially identical to the other ground contact portions used in the other embodiments. In addition, the ground portions may, but not necessarily, have the same geometry as the contact portions of the power terminals used in the same or different embodiments, but the ground contact portion may have a wider spacing between the jaws to receive a ground pin.

It should be understood that the embodiments in FIGS. 8A-8G are examples of various NEMA configurations wherein a reconfigurable terminal can be used to engage the plug blades that engage the apertures. Thus, a reconfigurable terminal can engage other plug blades of different NEMA configurations.

FIG. 9A is a bottom view and FIG. 9B is an isometric view of a NEMA 10-30 configuration (see FIG. 8C), including one L-shaped plug blade 250 and two straight plug blades 251, 252, wherein each plug blades extends through the socket aperture and engages with a respective terminal 190a, 190b, 190c. Terminal 190a includes a contact portion 220a, a clamp 200a, and a fastener 210a. Contact portion 220a includes a plurality of tabs 221a, 221b, 221c. Tab 221a of contact portion 220a engages a notch in clamp 200a. Thus, terminal 190a is in a second terminal configuration position (as shown in FIG. 3A). L-shaped plug blade 250 extends through the aperture and engages contact portion 220a of terminal 190a.

Terminal 190b includes contact portion 220b, clamp 200b, and fastener 210b. Contact portion 220b includes a plurality of tabs 222a, 222b, 222c. Tab 222b engages a notch on clamp 200b, and fastener 210b extends through an aperture on clamp 200b. Terminal 190b is in a first terminal configuration position (as shown in FIG. 2). Straight plug blade 251 extends through the socket aperture and engages contact portion 220b of terminal 190b. Terminal 190c is in a first terminal configuration position, and includes contact portion 220c, clamp 200c, and fastener 210c. Contact portion 220c includes a plurality of tabs 223a, 223b, 223c, with tab 223b engaging a notch in clamp 200c. Straight plug blade 252 extends through the socket aperture and engages contact portion 220c of terminal 190c.

In the exemplary embodiment in FIGS. 9A-9B, clamps 200a, 200b, 200c may, but not necessarily, be substantially identical. In addition, fasteners 210a, 210b, 210c may, but not necessarily, be substantially identical; and, contact portions 220a, 220b, 220c may, but not necessarily, be substantially identical. Each of terminals 190a, 190b, 190c are configured according to a desired or predetermined orientation.

While certain embodiments of the disclosure have been described herein, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision additional modifications, features, and advantages within the scope and spirit of the claims appended hereto.

What is claimed is:

1. An electrical receptacle terminal for receiving an electrical plug blade, said terminal comprising:
a) a contact portion having a tabbed end including a plurality of tabs and a plug blade end configured to receive said electrical plug blade;
b) a clamp having a first notch and an aperture, wherein said first notch is arranged and configured to engage any one of said plurality of tabs; and
c) a fastener having a surface that is adapted and configured for selectively and securingly engaging said aperture;
wherein said terminal is capable of being configured into a plurality of configurations depending on which one of said plurality of tabs said first notch engages.

2. The terminal of claim 1, wherein said contact portion is disposed at an angle to said clamp.

3. The terminal of claim 2, wherein said angle is substantially ninety degrees.

4. The terminal of claim 1, wherein said contact portion is one selected from the group consisting of a ground contact portion and a power contact portion.

5. The terminal of claim 1, wherein said plurality of tabs comprises a first tab, a second tab and a third tab, wherein said terminal is in a first, second or third terminal configuration when said first, second or third tab is engaged with said first notch, respectively.

6. The terminal of claim 1, said clamp further comprising:
a) first and second walls disposed in opposing relation to one another; and
b) third and fourth walls disposed in opposing relation to one another, each of said third and fourth walls further disposed between opposite distal ends of said first and second walls;
wherein said fourth wall includes said aperture and one of said first or second wall includes at least part of said first notch.

7. The terminal of claim 6, wherein at least one of said first and second wall is disposed at an angle to said third and fourth walls.

8. The terminal of claim 6, wherein each of said first and second walls are disposed at angles to said third and fourth walls.

9. The terminal of claim 6, wherein said first and second walls each include a portion of said first notch.

10. The terminal of claim 1, wherein said clamp further comprises a channel for receiving a conductor, wherein said channel is positioned between said first notch and said aperture.

11. The terminal of claim 10, wherein said fastener is configured to securely engage said conductor in said channel.

12. An electrical receptacle for receiving an electrical plug, said receptacle comprising:
a) a cover portion having an opening for one or more sockets for receiving a plug, said receptacle being configured to provide electrical power to said plug from conductors disposed at least partially within an electrical box, wherein each of said one or more sockets includes a plurality of apertures to receive said plug;
b) a plurality of electrical receptacle terminals wherein each of said terminals comprise:
i. a contact portion having a tabbed end including a plurality of tabs and a plug blade end configured to receive said electrical plug blade;
ii. a clamp having a first notch and an aperture, wherein said first notch is arranged and configured to engage any one of said plurality of tabs; and
iii. a fastener having a surface that is adapted and configured for selectively and securingly engaging said aperture;
wherein each of said plurality of terminals are capable of being configured into a plurality of configurations depending on which one of said plurality of tabs said first notch engages; and
c) a base portion adapted and configured to receive said cover portion, wherein said base portion includes a plurality of openings that are each configured to receive one of said terminals,
wherein each of said plurality of terminals is in a terminal configuration position that aligns with one of said apertures in said socket and one of said openings in said base portion.

13. The electrical receptacle of claim 12, wherein each of said contact portions is disposed at an angle to said respective clamp.

14. The electrical receptacle of claim 13, wherein said angle is substantially ninety degrees.

15. The electrical receptacle of claim 12, wherein at least one of said terminals is a ground terminal, and wherein said contact portion of said ground terminal is a ground contact portion configured to receive a ground pin.

16. The electrical receptacle of claim 12, wherein said plurality of tabs of each of said contact portions comprises a first tab, a second tab and a third tab, wherein each of said terminals are in a first, second or third terminal configuration when said first, second or third tab is engaged with said first notch, respectively.

17. The electrical receptacle of claim 12, each of said clamps further comprising:
a) first and second walls disposed in opposing relation to one another; and
b) third and fourth walls disposed in opposing relation to one another, each of said third and fourth walls further disposed between opposite distal ends of said first and second walls;
wherein said fourth wall includes said aperture and one of said first or second wall includes at least part of said first notch.

18. The electrical receptacle of claim 17, wherein at least one of said first and second wall is disposed at an angle to said third and fourth walls.

19. The electrical receptacle of claim 17, wherein each of said first and second walls are disposed at angles to said third and fourth walls.

20. The electrical receptacle of claim 17, wherein said first and second walls each include a portion of said first notch.

21. The electrical receptacle of claim 12, wherein each of said clamps further comprise a channel for receiving a conductor, wherein said channel is positioned between said first notch and said aperture.

22. The electrical receptacle of claim 21, wherein each of said fasteners are configured to securely engage said respective conductor in said respective channel.

23. A method of assembling an electrical receptacle terminal for receiving an electrical plug blade, comprising the steps of:
a) engaging one of a plurality of tabs of a contact portion with a first notch of a clamp, wherein any one of said plurality of tabs engages with said first notch according to a predetermined orientation of said terminal; and
b) inserting a fastener into an aperture of said clamp, wherein said fastener has a surface that is adapted and configured for selectively and securingly engaging said aperture.

24. The method of claim 23, wherein said contact portion is disposed at an angle to said clamp.

25. A method of assembling an electrical receptacle for receiving an electrical plug having a plurality of plug blades, said plurality of plug blades having predetermined plug blade orientations, the method comprising the steps of:
a) assembling a plurality of terminals having terminal orientations corresponding to said plurality of plug blades, respectively, wherein said step of assembling each of said terminals comprises:
i. engaging one of a plurality of tabs of a contact portion with a first notch of a clamp, wherein any one of said plurality of tabs engages with said first notch according to at least one of said predetermined plug blade orientations; and
ii. inserting a fastener into an aperture of said clamp, wherein said fastener and said aperture are adapted for selectively and securingly engaging one another; and
b) inserting each of said plurality of terminals into one of a plurality of openings in a base portion according to said predetermined plug blade orientation.

26. The method of claim 25, further comprising the step of engaging a cover with said base portion.

27. The method of claim 25, wherein at least one of said contact portions is a ground contact portion configured to receive a ground pin.

28. The method of claim 25 further comprising the steps of:
a) positioning a conductor between said first notch and said aperture of said clamp; and
b) tightening said fastener to hold said conductor against said tab of said contact portion that is engaged with said first notch.
